(19) United States
(12) Patent Application Publication
(10) Pub. No.: US 2005/0132783 A1
(43) Pub. Date: Jun. 23, 2005

(54) Rheometer

(75) Inventors: Pierre Reinheimer, Strasbourg (FR); Jint Nijman, Bretten (DE); Wolfgang Marquardt, Weingarten (DE)

Correspondence Address: LICHTI LEMPERT & LASCH, BERGWALDSTR. 1, D- 76227, KARLSRUHE, DE

(73) Assignee: Thermo Electron (Karlsruhe) GmbH, Karlsruhe (DE)

(21) Appl. No.: 10/970,701

(22) Filed: Oct. 22, 2004

(30) Foreign Application Priority Data
Oct. 29, 2003 (DE) 103 50 554.7

(51) Int. Cl. G01N 11/14

(52) U.S. Cl. 73/54.28

(57) ABSTRACT

A rheometer, in particular, a rotational or extensional rheometer, comprises a lower measuring part and an upper measuring part, between which a sample space is formed for receiving a material sample, and which can be moved relative to each other. The sample space is surrounded at a distance by a cover which forms an inner closed measuring chamber, wherein a temperature sensor for detecting the temperature within the measuring chamber and a temperature control device for the measuring chamber are provided. A further sensor device serves to detect the air moisture and/or the pressure within the measuring chamber, wherein a gas and/or liquid can be supplied to the measuring chamber and can be discharged therefrom via a discharge line.

This application claims Paris Convention priority of DE 103 50 554.7 filed Oct. 29, 2003 the complete disclosure of which is hereby incorporated by reference.

### BACKGROUND OF THE INVENTION

The invention concerns a rheometer, in particular, a rotational or extensional rheometer, comprising a lower measuring part and an upper measuring part, between which a sample space is formed for receiving a material sample, and which can be moved relative to each other, wherein the sample space is surrounded, at a separation, by a cover, to form an inner, closed measuring chamber, and with a temperature sensor for detecting the temperature in the measuring chamber and a temperature control device for the measuring chamber.

A rheometer for determining rheological values or characteristics of a viscous material usually comprises a lower measuring part and an upper measuring part which can be adjusted relative to the lower measuring part. The upper measuring part of a rotational rheometer can be rotated or oscillated. A sample space for receiving a sample of the substance to be examined is formed between the measuring parts. The forces and tensions which occur during relative adjustment between the upper and lower measuring parts can be determined, from which the desired rheological characteristics can be calculated.

In an extensional or stretching rheometer, the upper measuring part can be axially adjusted relative to the lower measuring part. In one particular embodiment of an extensional rheometer, the measurement is based on the exact knowledge of the time-dependent diameter of the material sample which is extended between the two measuring parts. The rheological properties of most material samples are highly temperature-dependent. For this reason, in a known design of a rheometer, a hood-like cover is provided which surrounds the sample space at a separation and forms a substantially closed inner measuring chamber whose temperature is controlled. The temperature inside of the measuring chamber is detected using a temperature sensor and a temperature-control device, e.g. an electric heating device or a so-called Peltier temperature control is provided to keep the temperature within the measuring chamber at a predetermined value.

The rheological characteristics of certain material samples, such as food or colors, also largely depend on the surrounding conditions during the measurement. There is, in particular, the danger that the material sample dessicates during the measurement. This problem occurs, in particular, in an extensional rheometer, since extension of the material sample largely increases its surface thereby considerably increasing exposure of the material sample to the surrounding conditions. In a conventional rheometer, excessive dessication of the material sample is prevented by the cover used.

In practice, it has, however, turned out that variations in the measured rheological values occur despite the use of a cover and despite constant or at least approximately constant temperatures within the measuring chamber.

It is the underlying purpose of the invention to provide a rheometer of the above-mentioned type for determining rheological characteristics of a material sample with great accuracy and reproducibility.

### SUMMARY OF THE INVENTION

This object is achieved in accordance with the invention with a rheometer comprising the features characterizing the independent claim. A further sensor device is thereby provided for detecting the air moisture and/or the pressure within the measuring chamber, and gas and/or liquid can be supplied to the measuring chamber via a supply line or be discharged via a discharge line.

The invention is based on the fundamental idea that variations in the rheological characteristics of a conventional rheometer are based mainly on the fact that the ambient conditions of a measuring chamber surrounded by a cover, cannot be controlled. In particular, the air moisture or the liquid, in particular solvent, saturation of the gaseous medium located within the measuring chamber, are unknown and subject to great variations in practice. This may have a strong influence on the accuracy of the rheological measurement. In accordance with the invention, the ambient conditions of the material sample within the measuring chamber are set, maintained or optionally changed in a controlled manner. Towards this end, the liquid or solvent saturation of the gaseous medium located within the measuring chamber is detected. Since the gaseous medium is generally air and the solvent is generally water, the term “air moisture” is used for simplification. The invention is, however, not limited to these media or substances. Additionally or alternatively, the pressure within the measuring chamber is also detected. The status data detected by the sensor device is passed to a control device in the form of actual signals. The control device checks whether the actual signals concerning the actual pressure and/or the actual air moisture within the measuring chamber correspond to predetermined desired signals, within predetermined limits. If the predetermined limit values are fallen below or exceeded, the control device may initiate supply or discharge gas, e.g. air and/or solvent, e.g. water, into or out of the measuring chamber. In this manner, the actual pressure within the measuring chamber and/or the actual air moisture within the measuring chamber can be kept at predetermined, desired and, in particular, constant values.

The cover should surround the sample space at a minimum separation such that the measuring chamber has a relatively small volume. This permits rapid compensation of changes or variations in the pressure and/or air moisture in the measuring chamber.

In a preferred embodiment, the liquid, in particular water, is supplied to the measuring chamber in the form of mist or aerosol.

The temperature sensor and/or the sensor device for detecting the pressure and/or the air moisture may be disposed directly in the cover. It is, however, also possible to dispose these sensors within the measuring chamber or also directly on the material sample or in its vicinity.

In a further development of the invention, an analysis sensor is additionally provided for detecting the composition of the gaseous medium, in particular air, located in the measuring chamber. In this manner, the composition of the gaseous medium located in the measuring chamber can be taken into consideration in the calculation of the rheological characteristics.

Further details and features of the invention can be extracted from the following description of embodiments with reference to the drawing.

### BRIEF DESCRIPTION OF THE DRAWING

FIG. 1 shows a schematic sectional view of an extensional rheometer; and

FIG. 2 shows a schematic sectional view of a rotational rheometer.

### DESCRIPTION OF THE PREFERRED EMBODIMENT

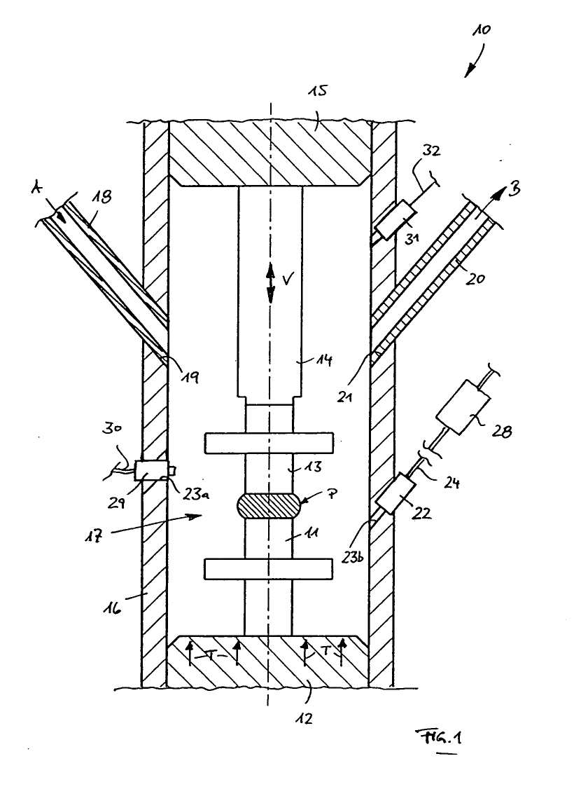

FIG. 1 shows a rheometer 10 in the form of an extensional rheometer comprising a lower base part 12 which bears an upwardly projecting die which forms a lower measuring part 11. An upper die-shaped measuring part 13 is disposed above the lower measuring part 11, is connected to a shaft 14 on its side facing away from the lower measuring part 11, and can be adjusted together with same in the axial direction (indicated by double arrow V). A sample space is formed between the lower measuring part 11 and the upper measuring part 13, in which a material sample is disposed which is in contact with the lower measuring part 11 and the upper measuring part 13. Through axial displacement of the upper measuring part 13 relative to the lower measuring part 11, the dimensions of the sample space can be enlarged thereby extending or stretching the material sample P. The shaft 14 is connected to an upper holding part 15 at its upper end facing away from the material sample P.

The lower base part 12, the lower measuring part 11, the upper measuring part 13, the shaft 14 and the upper holding part 15 are surrounded by a housing-like cover 16 whose inside defines a measuring chamber 17 in which the rheological characteristics of the material sample P are measured. The measuring chamber 17 is filled with a gaseous medium, in particular, with air. The wall of the cover 16 has a first opening 23a which houses a temperature sensor 29 for detecting the temperature within the measuring chamber 17. The temperature in the measuring chamber 17 may also be conventionally controlled using a temperature-control device T (only schematically shown). Cooperation between the temperature sensor 29 and the temperature-control device T permits maintenance of the temperature in the measuring chamber 17 at a predetermined value.

The wall of the cover 16 has a further opening 23b close to the material sample P within which a sensor device 22 for detecting the pressure and/or the air moisture in the measuring chamber 17 is disposed. The sensor device 22 is connected to a control device 28 via a line 24. A supply line 18 is disposed in a further opening 19 of the wall of the cover 16 which terminates in the measuring chamber 17 and through which a gas, in particular, air and/or a solvent, in particular water, can be supplied to the measuring chamber 17 (indicated by arrow A).

A discharge line 20 is located in a further opening 21 of the wall of the cover 16 through which air and/or the solvent can be discharged from the measuring chamber 17, in particular suctioned (as indicated by arrow B).

The cover 16 moreover comprises an analysis sensor 31 for detecting the composition of the gaseous medium located in the measuring chamber 17 and transferring same to a storage or calculation unit (not shown) via a line 32.

The sensor device 22 detects the actual condition in the measuring chamber with respect to actual pressure and/or actual air moisture and transmits corresponding actual signals to the control device 28 which compares the actual signals with predetermined desired values. In dependence on the actual signals of the sensor devices 22, the supply or discharge of gas and/or solvent into or out of the measuring chamber 17 is controlled by the control device. In this manner, it is possible to ensure predetermined ambient conditions with regard to pressure and/or air moisture and/or temperature in the measuring chamber 17, and thereby determine the rheological characteristics of the material sample P in the defined surrounding conditions.

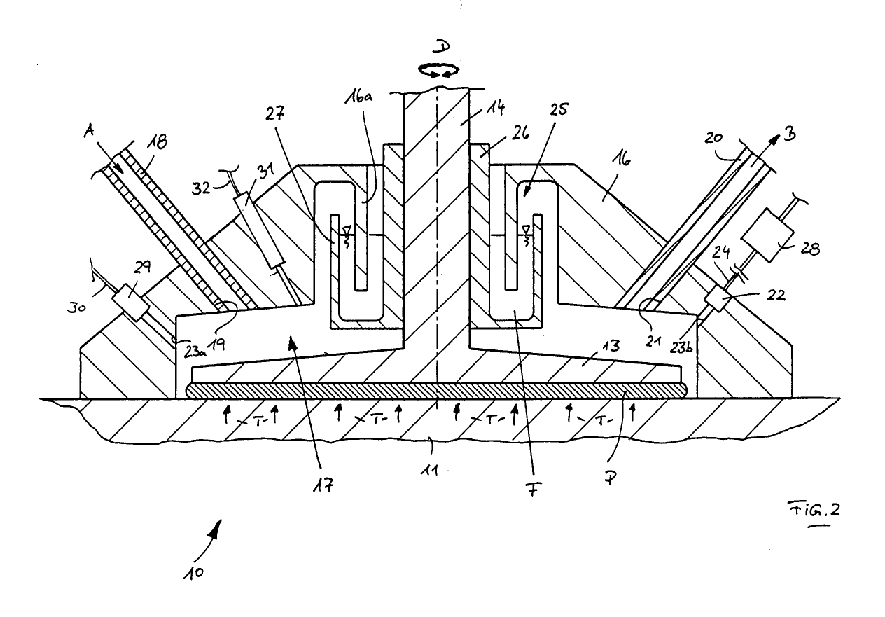

FIG. 2 shows a rotational rheometer 10 which also embodies the invention. The rheometer 10 has an upper measuring part 13 which is connected to a rotatable or pivotable shaft 14 (indicated by arrow D). The upper measuring part 13 has the shape of a substantially horizontal plate which is disposed at a separation above the surface of a lower measuring part 11. A sample space, which contains a material sample P, is formed between the lower measuring part 11 and the upper measuring part 13.

The sample space and the upper measuring part 13 are covered at a separation by a hood-like cover 16 which is supported at its outer end region on the surface of the lower measuring part 11 and sealed. At its radial inner end close to the shaft 14, the cover 16 is sealed-off from the shaft 14 via a fluid seal 25. The fluid seal 25 comprises a supporting sleeve 26, disposed on the shaft 14, which has a radially outwardly projecting shoulder 27 of L-shaped cross-section, to form an annular chamber which extends around the supporting sleeve 26. The cover 16 has a sleeve-like projection 16a at its radially inner end, which extends parallel to the sealing sleeve 26 and is immersed into the sealing liquid F. In this manner, a measuring chamber 17 which is formed inside the cover 16 and surrounds the sample space, the material sample P, and the upper measuring part 13, is sealed from the surroundings by the fluid seal 25.

The hood-like cover 16 has a first opening 23a which houses a temperature sensor 29 for detecting the temperature within the measuring chamber 17. The temperature of the lower measuring part 11 and of the material sample P may be controlled in a conventional manner via a temperature control device T (only schematically indicated). The temperature sensor 29 transmits temperature signals via a data line 30, which form the basis for keeping the temperature within the measuring chamber 17 at a constant value using the temperature-control device T.

The cover 16 has a second opening 23b which houses a sensor device 22 for detecting the air moisture and/or the pressure within the measuring chamber 17. The sensor device 22 transmits corresponding actual signals to a control device 28 via a line 24.

A supply line 18 penetrates the cover 16 at a further opening 19. Gas and/or solvent, in particular in the form of mist, may be introduced into the measuring chamber 17 via the supply line 18. In correspondence thereto, gas and/or solvent may be discharged from the measuring chamber 17 via a discharge line 20 which is located in a corresponding opening 21 of the cover 16. The supply and discharge are indicated by arrows A and B, respectively.

The hood-like cover 16 also comprises an analysis sensor 32 for detecting the composition of the gas located in the measuring chamber 17. The analysis sensor 31 transmits corresponding data to a storage or calculation unit via a line 32.

Cooperation between the sensor device 22 and the control device 28 and supply and discharge of gas and/or solvent into or from the measuring chamber 17 permits adjustment or maintenance of the ambient conditions of the material sample P within the measuring chamber 17 as desired.

1. A rheometer for measuring properties of a sample, the rheometer comprising:
a lower measuring part;
an upper measuring part spaced apart from said lower measuring part to define a sample space for receiving the sample between said upper and said lower measuring parts;
means for moving said upper measuring part relative to said lower measuring part;
a cover surrounding said sample space at a separation therefrom, said cover defining an inner closed measuring chamber;
a temperature sensor for detecting a temperature within said measuring chamber;
means for controlling said temperature within said measuring chamber;
a further sensor device for detecting at least one of air moisture and pressure within said measuring chamber;
means for supplying a gas or liquid to said measuring chamber via a supply line; and
means for discharging said gas or liquid via a discharge line.

2. The rheometer of claim 1, wherein the rheometer is a rotational rheometer.

3. The rheometer of claim 1, wherein the rheometer is an extensional rheometer.

4. The rheometer of claim 1, further comprising a control, wherein said further sensor device transmits actual signals to said control device concerning a current pressure or a current air moisture within said measuring chamber and said control device controls supply or discharge of gas liquid into or from said measuring chamber in dependence on said actual signals.

5. The rheometer of claim 4, wherein said control device compares said actual signals with desired signals and keeps said pressure and/or said air moisture within said measuring chamber at predetermined desired values.

6. The rheometer of claim 5, wherein said predetermined desired values are constant values.

7. The rheometer of claim 1, wherein said liquid can be supplied to said measuring chamber as a mist or aerosol.

8. The rheometer of claim 7, wherein said liquid is water.

9. The rheometer of claim 1, wherein at least one of said temperature sensor and said further sensor device are disposed in said cover.

10. The rheometer of claim 1, further comprising an analysis sensor for detecting a composition of a gaseous medium located in said measuring chamber.
